(19) United States
(12) Patent Application Publication
(10) Pub. No.: US 2011/0233183 A1
(43) Pub. Date: Sep. 29, 2011

(54) STEERING WHEEL HEATER ASSEMBLY

(75) Inventors: Darrel B. Saunders, Windsor (CA); Robert Charles Echlin, Windsor (CA)

(73) Assignee: North American Rescue, LLC., Greer, SC (US)

(21) Appl. No.: 13/061,467

(22) PCT Filed: Sep. 3, 2009
(86) PCT No.: PCT/US09/55897

§ 371 Date: Jun. 8, 2011

Related U.S. Application Data
(60) Provisional application No. 61/094,001, filed on Sep. 3, 2008.

(51) Int. Cl. B62D 1/04; B32B 38/14; B60L 1/04

(52) U.S. Cl. 219/204; 156/242

(57) ABSTRACT

A steering wheel heater assembly comprising a first layer made from a flexible mesh material, the first layer circumferentially wrapped around the steering wheel to add strength and durability to the heating assembly and to prevent movement of the heating assembly; a second layer comprising a double-sided adhesive for bonding the first layer to the steering wheel and to a third layer comprising a substrate made of polyamide material for distributing heat to the steering wheel; a fourth layer comprising a resistive material made from a carbon polymer; a fifth layer comprising a conductive layer of polymer based silver for providing electrical current to the steering wheel; and a sixth layer comprising a double-sided adhesive for insulating the fifth layer and for bonding the fifth layer to a seventh layer comprising a material for covering the exterior of the heater assembly.

This application claims the benefit of and priority to U.S. Provisional Patent Application No. 61/094,001, filed Sep. 3, 2008, titled: STEERING WHEEL HEATER ASSEMBLY, in the name of Saunders et al. which is incorporated by reference herein.

### BACKGROUND

The present disclosure relates generally to the field of vehicle steering mechanisms. More specifically, this disclosure relates to a steering wheel heater assembly and method for heating a steering wheel.

Conventional steering wheels are constructed of a cast magnesium armature that is subsequently over molded with a urethane foam covering. A heating element is then placed around the steering wheel. A closed cell foam or urethane rubber backed leather cover is then applied and sewn into place. Conventional steering wheel heaters provide inconsistent heat coverage and comfort, use a significant amount of power, and are overly susceptible to damage through repetitive use over time.

There remains a significant and long-continuing need to provide an improved steering wheel heater assembly that provides greater performance and competitive advantages over known steering wheel heater assemblies. In particular it would be advantageous to provide an improved steering wheel heater that provides consistent heat coverage and comfort, requires less power, has greater strength and resistance to damage, has a longer lifespan, and provides a means to selectively adjust the temperature of specific areas of the steering wheel.

### SUMMARY

A steering wheel heater assembly comprising a first layer made from a flexible mesh material, the first layer circumferentially wrapped around the steering wheel to add strength and durability to the heating assembly and to prevent movement of the heating assembly; a second layer comprising a double-sided adhesive for bonding the first layer to the steering wheel and to a third layer comprising a substrate made of polyamide material for distributing heat to the steering wheel; a fourth layer comprising a resistive material made from a carbon polymer; a fifth layer comprising a conductive layer of polymer based silver for providing electrical current to the steering wheel; and a sixth layer comprising a double-sided adhesive for insulating the fifth layer and for bonding the fifth layer to a seventh layer comprising a material for covering the exterior of the heater assembly

### BRIEF DESCRIPTION OF THE DRAWINGS

FIG. 1 is a perspective view of a vehicle having a seat assembly, according to an exemplary embodiment;

FIG. 2 is a front view of a steering wheel for a vehicle, according to an exemplary embodiment;

FIG. 3A is a plan view of a steering wheel heater assembly, according to an exemplary embodiment;

FIG. 3B is a plan view of a steering wheel heater assembly, according to an exemplary embodiment;

FIG. 3C is a plan view of a steering wheel heater assembly, according to an exemplary embodiment;

FIG. 3D is a plan view of a steering wheel heater assembly, according to an exemplary embodiment;

FIG. 4 is an enlarged cross-sectional view of a steering wheel having a steering wheel heater, according to an exemplary embodiment; and

FIG. 5 is a flow chart of a global manufacturing process of the steering wheel heater assembly, according to an exemplary embodiment.

### DETAILED DESCRIPTION

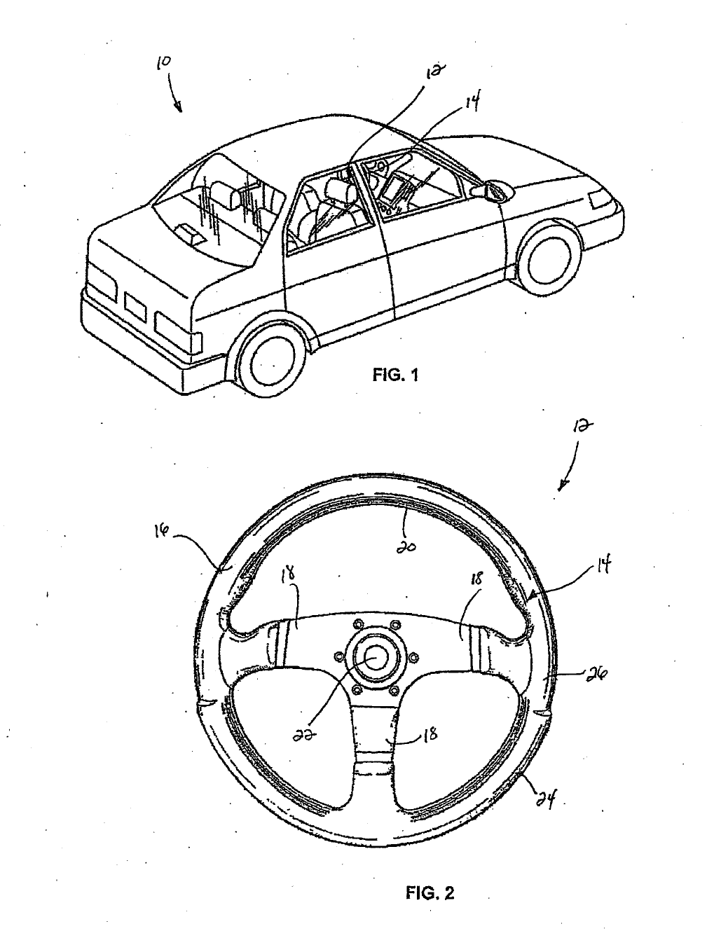

Referring generally to the figures and in particular to FIG. 1, a vehicle 10 is shown according to an exemplary embodiment. While the vehicle shown is a 4-door sedan, it should be understood that the steering wheel heater assembly may be used in a mini-van, sport utility vehicle or any other means in or by which someone travels such as planes and space travel and everything in between. The vehicle 10 includes, inter alfa, a steering wheel 12 and steering wheel heater assembly 14.

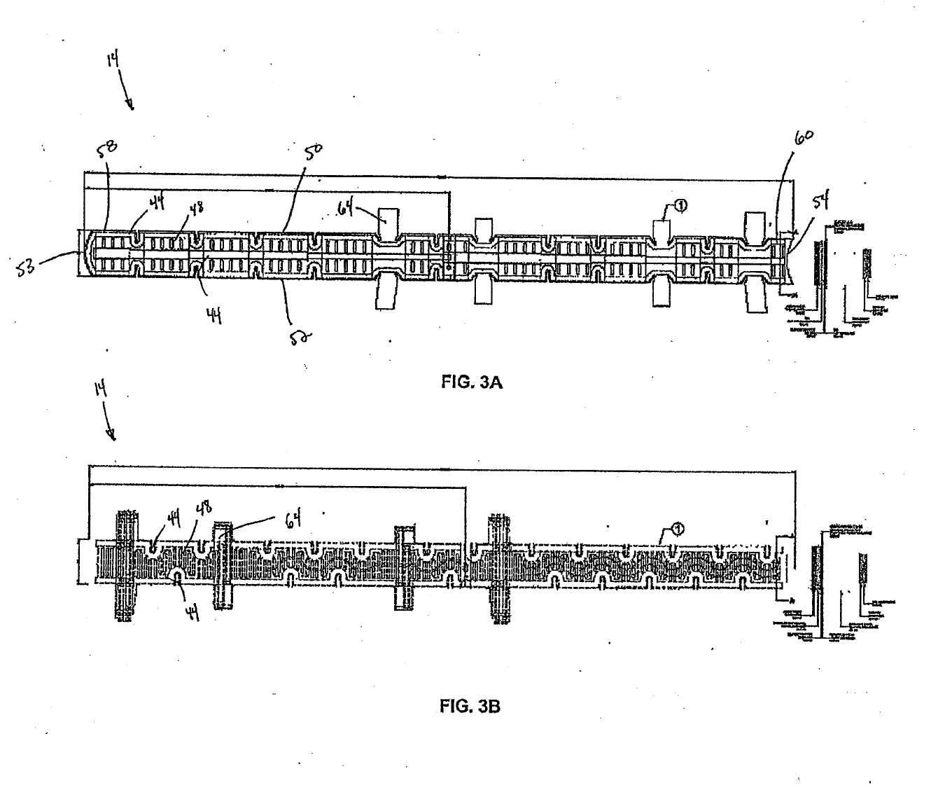

FIG. 2 shows a steering wheel assembly 12 for a vehicle 10, according to an exemplary embodiment. The steering wheel 12 is constructed in the form of a circular ring 14. A plurality of spokes 18 extend from the inner ring surface area 20 to the epicenter of the ring 22. The outer surface area 24 of the steering wheel 12 is covered with a material 26 (e.g., leather, vinyl, rubber, etc.) that enhances the grip and comfort of the vehicle 10 operator.

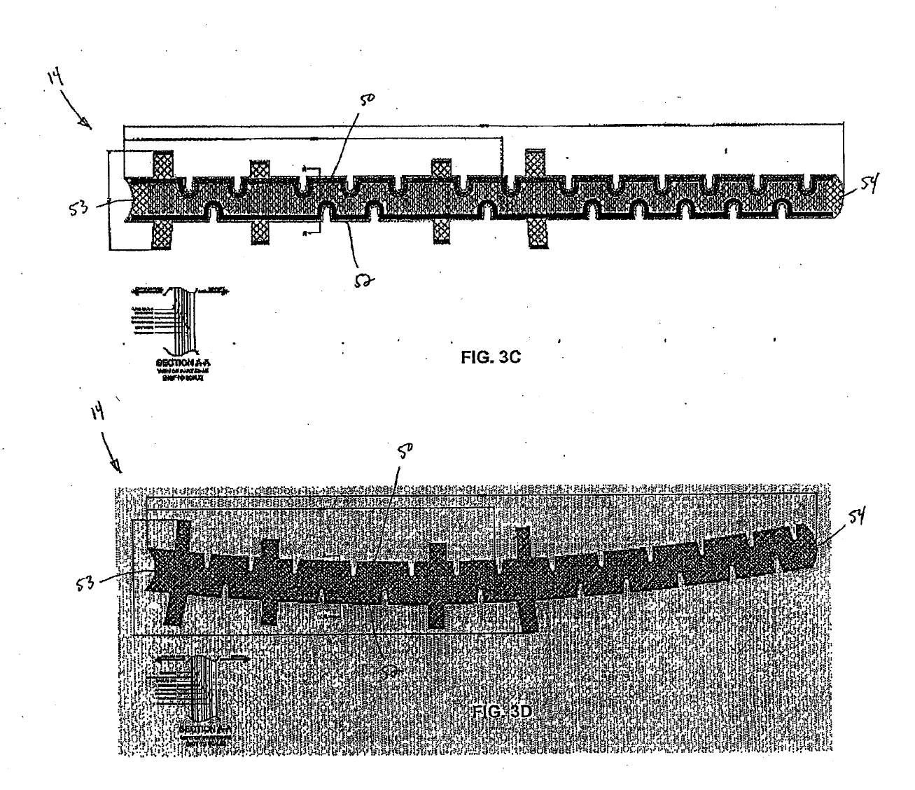

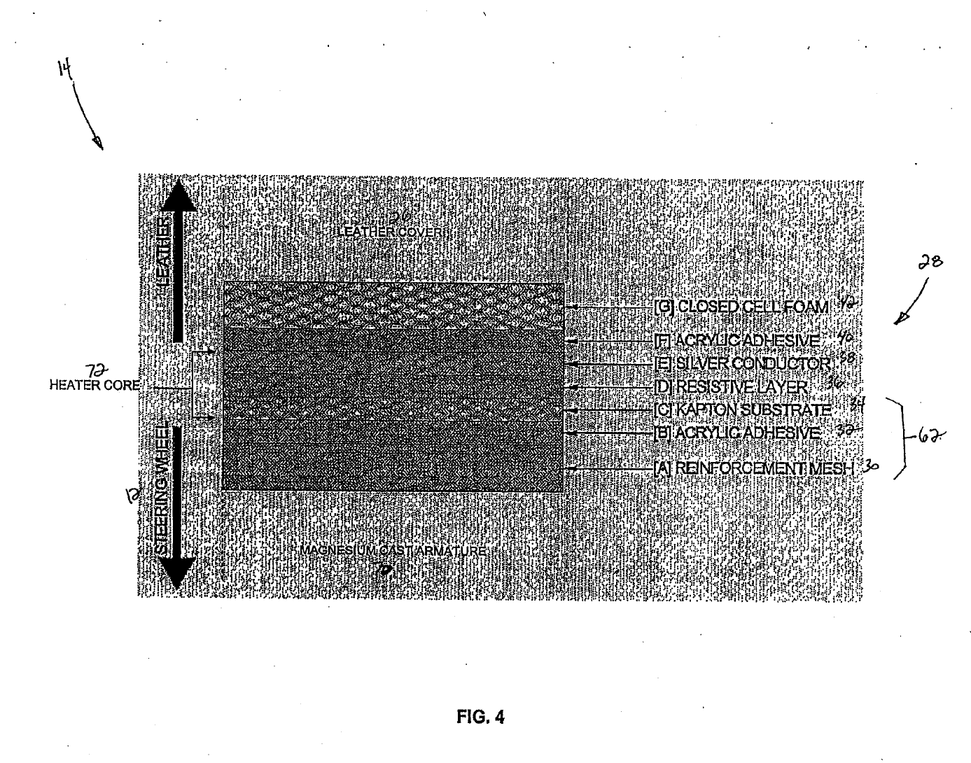

Referring now to FIGS. 3A through 4, a steering wheel heater assembly 14 is shown. The steering wheel heater assembly 14 is designed to circumferentially wrap around the steering wheel 12. The steering wheel heater assembly 14 is comprised of a plurality of layers 28 successively overlaid on one another and includes a reinforcement mesh layer 30, a first acrylic adhesive layer 32, a substrate layer 34, a resistive layer 36, a silver conductor layer 38, a second acrylic adhesive layer 40, a closed cell foam (e.g., neoprene, urethane) layer 42, as best shown in FIG. 4. According to a preferred embodiment, the substrate layer 34 is a polyamide based material, such as, Kapton®. After the printing process, the combined reinforcement mesh layer 30, first acrylic adhesive layer 32 and the substrate layer 34 (e.g. Kapton®, etc.) are perforated or die cut. This perforated or die cut design helps tweak the heat output in a specific area, enables the part to stretch slightly during the assembly process, and reduces the oil canning effect typically associated with polyamide films.

Although the substrate layer 34 (e.g. Kapton®, etc.) itself does not stretch, the geometric cutouts 44 designed along the entire surface 46 enable to product 14 to “stretch.” If the design merely entailed cutting out parallel side slots 48 perpendicular (i.e., at right angles) to the edges (first, second, third, fourth edge 50, 52, 54, 56) of the heater 14, the slots 48 would elongate and ripple as the opposing ends (first and second end 58, 60) are pulled. Therefore, the slots 48 have been designed through a three dimensional (3D) modeling technique which enables designing the heater 14 in its stretched state (which is approximately 7% longer than it its un-stretched state) with slots 48 having parallel sides. When the heater is relaxed the slots 48 become slightly hour glass shaped.

This combined layer 62 (i.e., reinforcement mesh layer 30, first acrylic adhesive layer 32 and substrate layer 34 (e.g. Kapton®, etc.)) also includes a series of darts 64 that are die cut along the perimeter. These darts 64 enable easier mounting of the combined layer 62 onto the steering wheel 12 and also create a better fit between the layers 28 and the steering wheel 12 when the steering wheel heater assembly 14 is sewn up.

The darts 64 perform the opposite of the slots 48. While the slots 48 are in the center of the heater 14, which is really the outer diameter 66 of the wheel 12, the darts 64 are on the inner diameter 68 which needs to be smaller. Through mathematical calculations, the overall size difference between the inner diameter 68 and outer diameter 66 is determined. The difference between these two diameters 66, 68 is then eliminated via the darts 64. This also helps in fitting a flat surface around a compound curve that even has finger holds designed into it.

Referring now to FIG. 4, an enlarged cross-sectional view of the steering wheel heater assembly 14 is shown. The steering wheel 12 is constructed from a cast magnesium armature 70 that is bound by a reinforcement mesh (Layer A) 30. A layer of acrylic adhesive (Layer B) 32 is applied on the surface of the reinforcement mesh 30 to adhesively bond a heating core 72 thereon. The heating core 72 comprises three materials successively layered on one another and includes a substrate layer made of a polyamide based material such as Kapton®, (Layer C) 34, a resistive carbon layer (Layer D) 36, and a silver conductor (Layer E) 38. A layer of acrylic adhesive (Layer F) 40 is applied on the surface of the heating core 72, and more specifically, on the surface of the silver conductor layer 38 so as to adhesively bond a closed cell foam (Layer G) 42, formed from a material such as neoprene or urethane, and the like thereon.

Layer A or the reinforcement mesh layer 30 may be made of any suitable material, but is preferably a fine nylon mesh. The reinforcement mesh 30 has openings or apertures 74 that are no smaller than 2 mm×2 mm which allows the adhesive layer 32 to bond both the mesh 30 to the heater 72 and the assembly 14 to the urethane coated armature 70. The reinforcement mesh 30 adds strength and durability to the steering wheel heater assembly 14 and protects the heater core 72. The mesh 30 also mitigates “running” (i.e., tears in the material of conventional steering wheel heater assemblies that continue to extend farther along the material over the course of time) via stop gaps (i.e., spaces/holes) 76 formed by the mesh 30 design. Yet another advantage of the reinforcement mesh layer 30 is that it grips into the urethane of the armature 70 to prevent the heater assembly 14 from moving (e.g., twisting, rotating, bunching, etc.) on the armature 70 and thus, eliminates the need for using neoprene. The reinforcement mesh layer 30 is also highly flexible by design and therefore, can be circumferentially wrapped around the steering wheel 12 evenly and with great ease—a feature particularly useful around the more intricate details of the steering wheel 12 (e.g., steering wheel spoke areas 78, steering wheel grip contours 80, steering wheel buttons 82, etc.).

Layer B or the first acrylic adhesive layer 32 is a double-sided adhesive (e.g., 3M #467, 3M #9672, etc.). The first acrylic adhesive layer 32 bonds the reinforcement mesh 30 to the substrate layer 34 (e.g. Kapton®, etc.) of the heating core 72 and thereby secures the heater 72 to the armature/urethane 70. Using 3M #9672 adhesive 32 allows for the adhesive (glue) to set after the first heating.

Layer C or the substrate layer is a polyamide 34 (e.g., Kapton®, DuPont 200HPPST or FIN, etc.) and according to an exemplary embodiment, may have a thickness of approximately 2 mm. Using a polyimide based material film (e.g. Kapton®, etc.) as the substrate layer 34 in lieu of existing technologies has a number of advantages. For example, by using either printed carbon Kapton® film or carbon co-fired Kapton® film, a greater surface area 24 (e.g., steering wheel 12) may be covered with heat and thereby enhance performance of the heater 14. In contrast, existing technologies that use a resistive wire heater typically have approximately ten strands evenly spaced running horizontally within a three inch wide area. The wire strands are typically very fine and are spaced apart from one another at approximately three-eighths of an inch. In order to create the perception that the wire heater is providing an even distribution of heat across a desired area, the wire heater must attain an adequate temperature to heat areas that are not in direct contact with the wire heater. To accomplish this, multiple wire strands are typically required. One drawback to these existing technologies is that there is typically a direct relationship between the number of strands used and the consumption of power. In other words, using more wire strands typically results in more power consumption. By using the polyamide based material (e.g. Kapton®, etc.) 34 film of the present disclosure, the entire surface area is resistive which, in turn, reduces the amount of power required to cover the same of amount of heated area as the complete surface area heats up and thereby enhances performance of the heater 14. For example, the polyamide based material (e.g. Kapton®, etc.) 34 film of the present disclosure requires approximately 3.8 to 4.2 amps per wheel heater 14, whereas existing technologies utilizing a resistive wire heater typically require approximately 8 amps per wheel heater. A further advantage of polyamide based material (e.g. Kapton®, etc.) 34 film of the present disclosure is that there is no tactile perception of hot spots while the entire surface area 24 temperature balances out, as with resistive wire heaters, because the complete surface area 24 heats up equally. Yet a further advantage of the polyamide based material (e.g. Kapton®, etc.) 34 film of the present disclosure is that there is no in-rush of current because the entire surface area has equal resistance and power conductors run parallel along the complete length of the heater 14—what current is needed to start, is what is used continuously. In contrast, existing technologies utilizing a resistive wire heater typically have a moderate to high in-rush current initially while the resistance in the wire is overcome. A further advantage of the heater 14 design of the present disclosure is that the heater 14 heats up at an even rate. Another drawback of existing technologies utilizing a resistive wire heater is that it they tend to be more susceptible to damage from liquids, such as, water. For example, water may seep or permeate through the insulation layer (perhaps as a result of the insulation layer melting down) and wreak havoc by causing the wire strands to rust which may lead to failure of the heater because if one localized area of the heater fails (e.g., one wire, spot on the wire, etc.), the entire heater fails. In contrast, the polyamide based material (e.g. Kapton®, etc.) 34 film of the present disclosure is much more durable and less susceptible to failure because current continues to flow everywhere except the specific damaged area (e.g., hole, rust, etc.).

Using polyamide based material (e.g. Kapton®, etc.) 34 films as a heater material also has a number of advantages over existing technologies which utilize polyester as a heater material. For example, the maximum temperature threshold for polyester is typically approximately 105° C. (at this temperature, polyester softens and becomes rippled and deformed). This is problematic for at least three reasons. First, although typical operating temperatures of steering wheels are approximately 65° C., this temperature may easily be exceeded via sun rays beaming through a vehicle windshield and may result in deformation of the polyester. Second, many inks require drying/curing temperatures of 100° C. and may inadvertently damage the polyester in the process. Third, polyester is not an ideal medium for printing carbons on it because of the inherent temperature limitations of polyester. Polyamide based material (e.g. Kapton®, etc.) films 34, on the other hand, can withstand a temperature threshold of 300° C. and some up to 700° C. which, in turn, enhances heater performance (e.g., improved control of ohms, etc.). Polyamide based material (e.g. Kapton®, etc.) films 34 are also less susceptible to damage from the temperature demands of drying/curing inks and are a more ideal medium for carbon printing. Another drawback of existing technologies utilizing polyester is that at elevated temperatures polyester is typically more susceptible to the adverse effects of hydrolysis than polyamide based material (e.g. Kapton®, etc.) films 34. In other words, existing technologies utilizing polyester material are more susceptible to absorbing moisture and degrading back into their semi-liquid state. This process may begin as low as 40° C. for polyester. In contrast, this process does not begin until 200° C. for certain polyamide based material (e.g. Kapton®, etc.) films 34 (depending on the grade) and therefore, polyamide based material (e.g. Kapton®, etc.) films 34 are not as absorbent.

Layer D or the resistive layer 36 is a screen printed or flexographically printed layer carbon polymer (e.g., Electra Polymers #ED9000) having a sheet resistivity determined by the required output temperature requirements. Sheet resistivity may be adjusted by the blend of carbon and or its thickness. A design criterion, according to an exemplary embodiment, is that the thickness never exceeds 20 μm dry. The pattern of the carbon layer 36 also dictates where the heat is produced and what intensity. As such, the output temperatures over the surface of the heater 14 may be selectively varied. For example, if the OEM desires the 3 and 9 o'clock areas of the steering wheel 12 to be one maximum temperature and the 6 and 9 o'clock areas of the steering wheel 12 to be a different temperature, then the carbon layer 36 design may be modified to accomplish this. A particular characteristic with this printed carbon technology is that there is a direct correlation between input voltage and output temperature. In other words, as long as voltage X is constant, wattage Y will also remain constant so temperature will reach a peak and remain there.

Layer E or the silver conductor layer 38 is also a printed layer of polymer based silver (e.g., DuPont #5025). This layer 38 may be two or more conductors in a pattern (redundancy in silver supply leads) that best suits the design and the power draw considerations for the complete heater 14. This also allows for building redundancy into the power supply leads 86 in case of damage over the life of the completed steering wheel 12. Moreover, the design of the silver conductor layer 38 provides 50% less power consumption than existing technology that is in use today. For example, the heater assembly 14 innovation disclosed herein typically requires 3.5 amps or less versus 7.5 amps or more for wire or carbon fiber based systems. This advantage enables the heater assembly 14 innovation disclosed herein to be powered through a clock spring 88 in the steering wheel 12 as opposed to a secondary set of contacts that add costs to the OEM. In short, this results in a minimum of 20% cost savings over existing technology.

Layer F or the second acrylic adhesive layer 40 is a double-sided adhesive (e.g., 3M #467, 3M #9672, etc.) like Layer B or the first acrylic adhesive layer 32. The second acrylic adhesive layer 40 also acts as a dielectric or electrically insulating covering over the printed surface.

Layer G or the closed cell foam layer 42 is the final layer which covers the exterior of the steering wheel heater assembly 14. It may be formed from any suitable material, such as neoprene or urethane which provides an enhanced grip for the vehicle 10 operator. According to an exemplary embodiment, it may have a thickness of approximately 1/64 to 1/16 inches which allows for better comfort and appearance for the completed steering wheel 12.

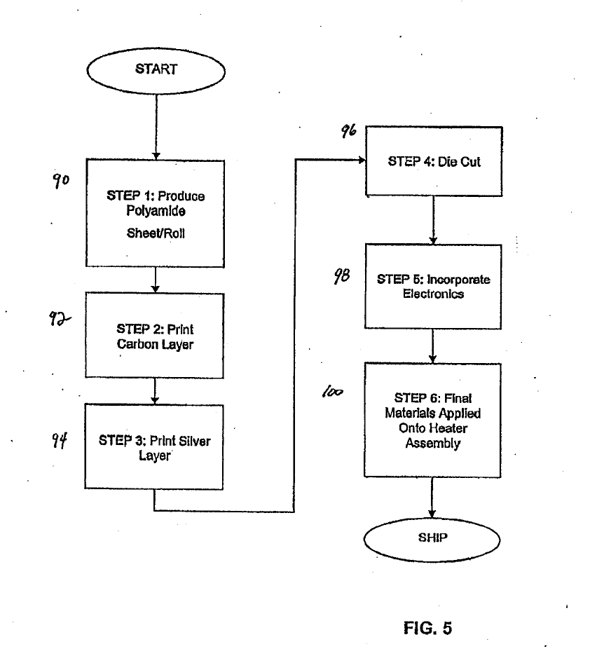

Referring now to FIG. 5, a flow chart of the global manufacturing process of the steering wheel heater assembly is shown. At step one 90, the polyamide is produced into a sheet or roll. At step two 92, a carbon layer is printed onto the polyamide and cured. Next, at step three 94, the silver conductor layer 38 is printed onto the polyamide and cured. The die is then cut (e.g., roll, laser, etc.) at step four 96. Next, at step five 98, various electronic components (e.g., thermometer 102, terminals for receiving electrical current 104, etc.) are incorporated into selected areas (i.e., bus area 106). At step six 100, the final materials are incorporated onto the heater assembly 14. A cover material 26 (e.g., neoprene/foam layer, etc.) is added to one side (exterior) of the heater assembly 14 and another material (e.g., a synthetic, etc.) is added to the other side (underside or interior). Adhesives are pre-applied to the foam layer 42 or alternatively may be applied during the manufacturing process. A wire harness 108 is added to complete the process and the heater assembly 14 is shipped.

According to an alternate embodiment, a double temperature control system 110 (e.g., PEPI Control System, etc.) is incorporated into the heater assembly 14 (not shown). An ultra-thin thermostat 112 is inserted into the backside of each spoke 114. The double temperature control system 110 enables the vehicle 10 operator to regulate the steering wheel 12 temperature within 1° C.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components or the two components and any additional member being attached to one another. Such joining may be permanent in nature or alternatively may be removable or releasable in nature.

It is also important to note that the construction and arrangement of the elements of the vehicle seat as shown in the preferred and other exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures and combinations. Accordingly, all such modifications are intended to be included within the scope of the present innovations. Other substitutions, modifications, changes and omissions may be made in the design, operating conditions and arrangement of the preferred and other exemplary embodiments without departing from the spirit of the present innovations.

What is claimed is:

1. A heater assembly for a steering wheel, the heater assembly comprising:
a first layer made from a flexible mesh material, the first layer circumferentially wrapped around the steering wheel to add strength and durability to the heating assembly and to prevent movement of the beating assembly;
a second layer comprising a double-sided adhesive for bonding the first layer to the steering wheel and to a third layer comprising a substrate made of polyamide material for distributing heat to the steering wheel;
a fourth layer comprising a resistive material made from a carbon polymer;
a fifth layer comprising a conductive layer of polymer based silver for providing electrical current to the steering wheel; and
a sixth layer comprising a double-sided adhesive for insulating the fifth layer and for bonding the fifth layer to a seventh layer comprising a material for covering the exterior of the heater assembly.

2. The heater assembly of claim 1, wherein the first layer further comprises apertures for enabling the second layer to bond the first layer to the third layer and the heating assembly to the steering wheel.

3. The heater assembly of claim 2, wherein the first layer further comprises a plurality of gaps to prevent the first layer from tearing.

4. The heater assembly of claim 1, wherein the third layer further comprises a plurality of parallel slots along the surface of the third layer to enhance flexibility of the heating assembly.

5. The heater assembly of claim 4, wherein the parallel slots have a hour glass shape prior which enables the heating assembly to stretch onto the steering wheel without creating ripples the heating assembly.

6. The heater assembly of claim 1, wherein the fourth layer is a flexographically printed layer carbon polymer.

7. The heater assembly of claim 1, wherein the fifth layer is a printed layer of polymer based silver.

8. The heater assembly of claim 7, wherein the fifth layer comprises a plurality of conductors.

9. The heater assembly of claim 1, wherein the first layer, second layer and third layer are bonded together to form a combined layer, the combined layer having a plurality of darts along the perimeter of the combined layer.

10. A steering wheel for a vehicle, the steering wheel comprising:
an armature;
a first layer made from a flexible mesh material, the first layer circumferentially wrapped around the steering wheel to add strength and durability to the heating assembly and to prevent movement of the heating assembly;
a second layer comprising a double-sided adhesive for bonding the first layer to the steering wheel and to a third layer comprising a substrate made of polyamide material for distributing heat to the steering wheel;
a fourth layer comprising a resistive material made from a carbon polymer;
a fifth layer comprising a conductive layer of polymer based silver for providing electrical current to the steering wheel;
a sixth layer comprising a double-sided adhesive for insulating the fifth layer and for bonding the fifth layer to a seventh layer comprising a material for covering the exterior of the heater assembly; and
a power supply line coupled to the heating assembly to supply electric power to the heat assembly.

11. A method of manufacturing a heating assembly for a steering wheel, the method comprising:
producing a sheet of polyamide;
printing a carbon layer onto the sheet of polyamide and curing the carbon layer thereon;
printing a silver conductor layer onto the sheet of polyamide combined with the carbon layer and curing the silver layer thereon;
fabricating the die;
coupling electronic components to the sheet of polyamide combined with the carbon layer and silver layer;
coupling additional components to the heater assembly.
